(19) United States
(12) Patent Application Publication
(10) Pub. No.: US 2007/0289950 A1
(43) Pub. Date: Dec. 20, 2007

(54) SHIELDED GAS WELDER SHUTDOWN SYSTEM

(75) Inventor: Tommy Lee Eyton, Boise, ID (US)

Correspondence Address: PAUL, HASTINGS, JANOFSKY & WALKER LLP, 875 15th Street, NW, Washington, DC, 20005, US

(73) Assignee: Lincoln Global, Inc.

(21) Appl. No.: 11/424,130

(22) Filed: Jun. 14, 2006

(51) Int. Cl. B23K 9/16

(52) U.S. Cl. 219/74; 219/125.1

(57) ABSTRACT

An invention is provided which contains a pressure isolation chamber coupled to a shielding gas system such that some of the shielding gas is directed to the isolation chamber and as the pressure in the shielding gas system decreases the pressure within the chamber decreases. The chamber is coupled to a pressure sensor or switch, which senses the pressure in the pressure isolation chamber. The pressure isolation chamber is blocked by a normally-closed valve such that if the system pressure increases, the pressure within the pressure isolation chamber does not increase accordingly, until the normally-closed valve is opened to allow the pressure in the pressure isolation chamber to equalize with the system pressure. The pressure switch is coupled to a control system such that when the pressure senses that the pressure in the pressure isolation chamber drops below a threshold the control system and/or the pressure switch ceases the welding operation so that a defective weld can not be created.

### FIELD OF THE INVENTION

The present invention is directed to a gas shutdown system, more specifically to a gas shutdown system which is used with a welding apparatus which uses a weld gas supplied to the weld during a welding operation.

### BACKGROUND OF THE INVENTION

In many welding operations, including Tungsten Inert Gas (TIG) and Metal Inert Gas (MIG), a pressurized inert gas is directed to the weld area, while the weld is being made. This inert gas is used to create an environment around the weld where oxidation, porosity and other defects, in the weld are prevented.

In the above, and many other types of welding operations, the constant flow of the inert gas is required to ensure the consistency and quality of the weld being made. Thus, when the supply of the inert gas is interrupted or otherwise affected, this can have an adverse affect on the weld. In fact, when the flow of the inert gas is depleted, stopped or otherwise flows below a specified pressure level, and the welding operation continues the weld quality is adversely affected such that the weld must be redone. This causes delay and an increase in expense as it is necessary to remove and redo the weld.

In an effort to avoid this expense, persons performing a welding operation often stop welding and replace the inert gas tank prematurely. Typically when this is done the tank still contains a significant amount of gas, such that a large amount of gas is wasted when the tank is emptied and refilled. Such waste increases the expense of the welding operation.

One method used to prevent problems associated with the loss or reduction of acceptable gas pressure is through the use of pressure gauges on the gas tank. However, it is often the case that the tank is not within the visual sight of the person conducting the weld or the welder fails to remember to continuously check the pressure gauge.

As such, a need is required for a low cost and highly reliable pressure monitoring system which will shut down the welding operation when the gas pressure drops below a certain threshold. Such a system will ensure that the welding operation only occurs when sufficient gas pressure exists in the gas supply system, and that the gas supply usage is optimized so that there is minimal waste. The present invention provides such a solution.

### SUMMARY OF THE INVENTION

As stated above, the present invention is directed to solve the above problems by providing a low cost and highly reliable system to monitor the gas pressure in the gas system and shut down the welding operation when the pressure drops below a certain threshold.

To accomplish this, an embodiment of the present invention contains a pressure isolation chamber that is coupled to a pressure sensor or switch, where the pressure in the pressure isolation chamber decreases as the system pressure decreases. Further, the pressure isolation chamber is blocked by a normally-closed valve such that if the system pressure increases, the pressure within the pressure isolation chamber does not increase accordingly, until the normally-closed valve is opened to allow the pressure in the pressure isolation chamber to equalize with the system pressure. Also, the pressure switch is coupled to a control system such that when the pressure senses that the pressure in the pressure isolation drops below a certain threshold the control system and/or the pressure switch ceases the welding operation so that a defective weld can not be created.

Various embodiments of the present invention will be discussed below.

### BRIEF DESCRIPTION OF THE DRAWINGS

The advantages, nature and various additional features of the invention will appear more fully upon consideration of the illustrative embodiments of the invention, which are schematically set forth in the figures, in which:

FIG. 1 is a diagrammatical representation of a welding system incorporating the welding gas shut down system according to an embodiment of the invention;

FIG. 2 is a diagrammatical representation of a welding system incorporating the welding gas shut down system according to another embodiment of the present invention;

FIG. 3 is a diagrammatical representation of a welding system incorporating the welding gas shut down system according to another alternative embodiment of the present invention; and

FIG. 4 is a diagrammatical representation of an embodiment of a gas shutdown manifold used with an embodiment of the present invention.

### DETAILED DESCRIPTION OF EXEMPLARY EMBODIMENTS

The present invention relates to a welding gas shut down system used to automatically shut down or stop a welding operation in gas shielded welding operations, such as TIG and MIG welding, to prevent welding from occurring when there is insufficient gas flow over the weld.

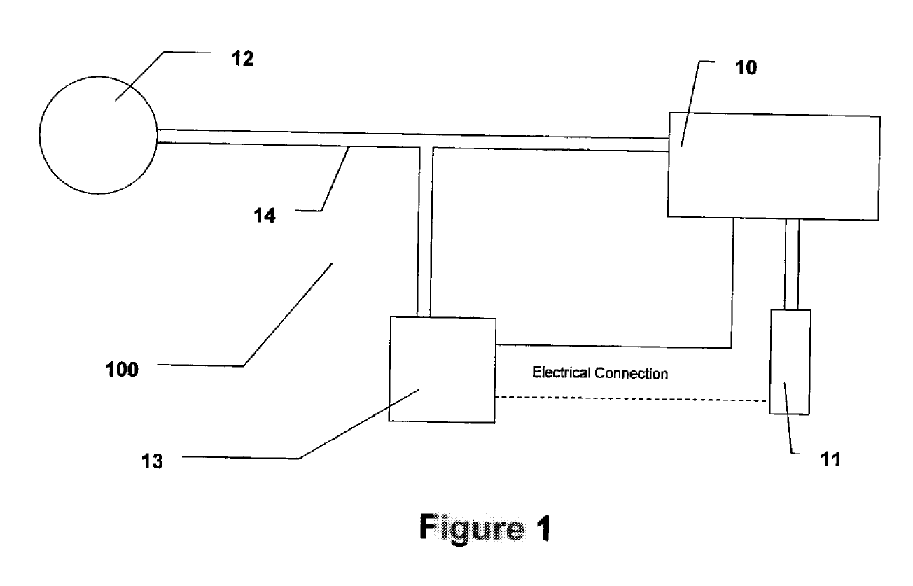

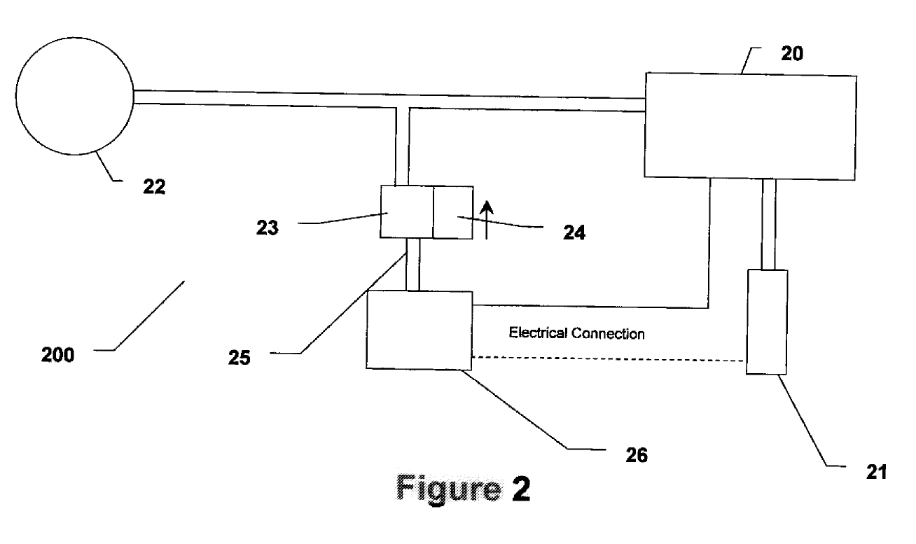

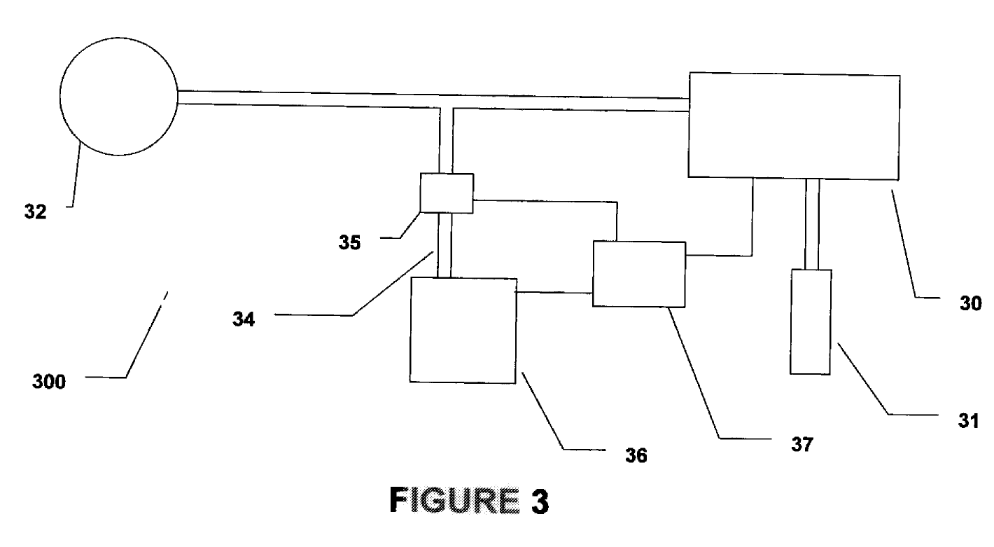

FIG. 1 depicts a welding system employing a first embodiment of the present invention, where a gas shutdown manifold is employed to contain the pressure isolation chamber, whereas FIG. 2 depicts a second embodiment of the present invention where a pressure isolation chamber is created by the use of a normally closed (NC) valve along with a pressure switch, and FIG. 3 depicts a third embodiment of the present invention where a normally closed solenoid controlled valve is used in conjunction with a control circuit. Each of these embodiments will be discussed in turn below. However, the present invention is not limited to these embodiments, as it is contemplated that various system structures may be used for the present invention.

It is noted that the following discussion is directed to embodiments of the present invention which are related to welding, in particular welding metal. However, the present invention is not limited to only this application, and may be used with cutting devices in cutting operations, or in any type of application where there is a requirement or a need for the monitoring of gas or fluid pressure within a system for the purposes of ensure that an operation, such as welding, is completed properly.

Turning now to FIG. 1, a welding system 100 is depicted which contains a welding device or welder 10, which is coupled to a welding gun 11. The welder 10 and welding gun 11, are used in a gas welding operation where there is a need for an inert gas to be directed to the weld area (e.g. MIG or TIG welding). The inert gas used for the shielding is provided from a gas tank 12 which is coupled to both the welder 10 and a gas shutdown manifold 13, via gas lines 14. The gas shutdown manifold contains a pressure isolation chamber, which contains a pressure equivalent to the operating pressure of the gas system, a pressure switch which sends out a signal based on the pressure reading of the pressure isolation chamber, a normally-closed valve, which is used to reset the pressure of the pressure isolation chamber and a one way directional valve to control the flow of gas into the pressure isolation chamber.

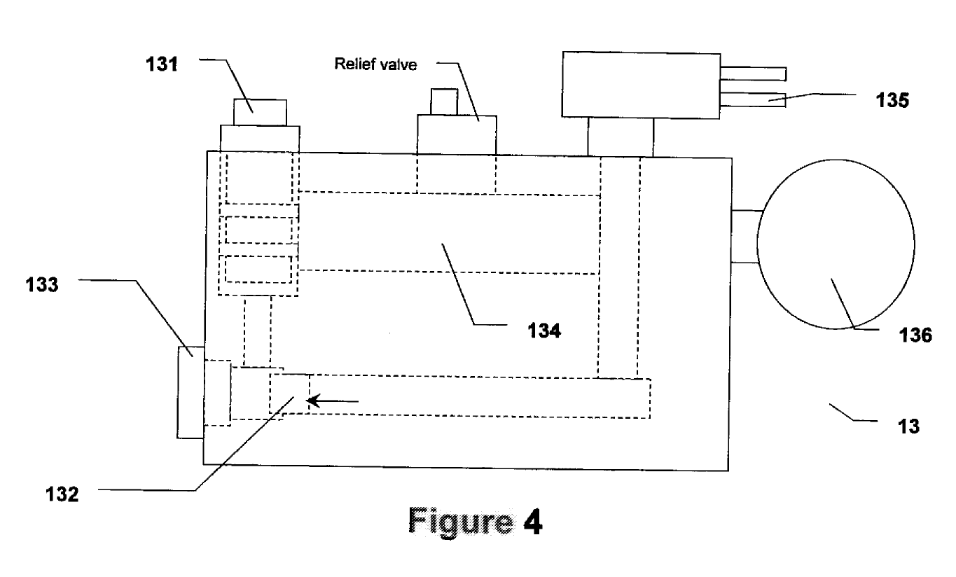

The detailed discussion of the structure an operation of an embodiment of the gas shutdown manifold 13 will be discussed below with reference to FIG. 4.

As shown in FIG. 1, the gas shutdown manifold 13, and more particularly, the pressure switch is electrically coupled to the welder or welding device 10 in such a way that when the pressure switch sends out a signal (or “opens” or “closes” depending on the switch design and system used), the welder 10 shuts down the welding operation. This will occur when the pressure switch senses a pressure within the pressure isolation chamber that is below a lower threshold limit. This limit can be set manually by the user, or automatically based on a number of inputs by the user. Typically, the lower pressure limit will be selected to be a pressure below which an unacceptable weld will occur.

In another embodiment, shown by the dashed lines in FIG. 1, the pressure switch of the gas shutdown manifold 13 is electrically coupled directly to the welding gun. In such an embodiment, the activation of the pressure switch will cause the wire feed mechanism (not shown) to shut down such that the electrode feed will not occur, thus preventing welding from continuing. It is noted that the present invention is not limited as to how the welding operation is ceased, and it is understood that many various and alternative methods and control system can be used to cause the welding device 10 or the welding gun 11 to shut down, thus preventing improper welding.

The following discussion will now focus on the operation of the present invention and the structure of an embodiment of the manifold 13, as shown in FIG. 4.

Prior to a welding operation, the welder 10 is off, and the system gas pressure, including the pressure in the tank 12, is at a steady state. The operator then opens any valve (not shown) on the tank 12 to allow the gas system to equalize.

By opening the valve (not shown) on the tank 12 the gas enters the inlet 133 of the manifold 13. As the gas enters, it impinges on a one-way directional or check valve 132 which prevents the flow from entering the pressure isolation chamber 134 through the check valve 132. The check valve 132 only permits flow in the direction shown by the arrow. The present invention contemplates using any kind of valve structure, such as check valves or ball valves, which permit gas or fluid flow in one direction, while preventing the flow in the opposite direction. The gas is then blocked from entering the pressure isolation chamber 134 by the normally closed or reset valve 131. Therefore, the pressure isolation chamber 134 is isolated from the gas system pressure by a combination of the normally closed valve 131 and the check valve 132. This isolation causes a dead-head pressure at the check valve 132 and the normally closed valve 131. Dead head pressure is the static pressure of the gas system, when the system is closed so that no gas flow is occurring. Typically, dead head pressure, or steady state pressure, is higher than the system dynamic pressure, which is the pressure within the system while the system is open, or when there is a flow of the gas exiting the system in some way. In a welding system the dead head pressure exists when no gas flow to the weld is taking place and the system is closed (for example 15 to 20 PSI), while the system dynamic pressure exists when a welding operation is taking place and gas is flowing from the system into the weld area (for example 2.5 to 4 PSI).

The operator then pushes open the normally closed valve 131, which temporarily opens the valve 131 to allow the system gas to enter the pressure isolation chamber 134 and allows the pressure throughout the manifold 13 to equalize with the system pressure of the gas supply system. Once the valve 131 is released it returns to the closed position. However, at this time the system pressure and the pressure within the pressure isolation chamber 134 are essentially the same. In an embodiment of the invention, the valve 131 is a mechanical valve. However, in an alternative embodiment, the valve 131 is an electrically controlled solenoid valve, which may controlled remotely by a switch either or the welder 10, the gun 11, or some other remote location. In such an embodiment, the valve 131 is held open temporarily while current is applied (via a switch), however, when the current is discontinued the valve 131 closes. In a further alternative embodiment, the valve 131 does not have to be a normally closed valve but can be any valve type mechanism which closes off the pressure isolation chamber 134 when welding begins. Thus, in such an embodiment, the valve can be an electrically controlled valve coupled to a control system (not shown) which automatically closes the valve when the welding operation begins. In such an embodiment, the operator opens the valve to allow the pressure in the pressure isolation chamber to equalize with the rest of the system, and if the pressure is high enough the welding operation may begin. Once the welding operation begins, the control system triggers the valve to close.

In an embodiment of a welding system having the present invention, the operator may then turn on the welder 10, and if the pressure sensor or switch 135 senses a sufficient pressure within the chamber 134, the welder 10 and welding gun 11 will be able to operate. In another embodiment of the invention, the normally closed valve 131 can be coupled to a switch or control circuit such that when the valve 131 is pushed open, the welder 10 is turned on, and or the operating system of the welder 10 is reset so as to begin operation. Of course, it is envisioned that various embodiments of system control can be used to turn on and control the welder 10, and the present invention is not limited to the above embodiments.

Once the system determines that a sufficient pressure level is present, via the pressure switch 135, the welding operation may begin where the inert gas is emitted from the gas system into the weld area. Once the inert gas begins to flow into the weld area, and as the inert gas supply is depleted, the gas system pressure level drops. As the pressure level of the system drops, the pressure in the pressure isolation chamber 135 also drops. This is because, as the gas system pressure drops the pressure within the chamber 134 also drops, as the gas in the chamber 134 exits through the check valve 132. Stated differently, as the pressure within the system drops (because of gas usage, etc.), the pressure on the downstream side of the check valve 132 becomes lower than the pressure within the chamber 134. This pressure differential causes the gas within the chamber 134 to push open and through the check valve 132 into the system. Because of this configuration of the present invention, the pressure within the chamber 134 is continuously decreased along with the decrease in the system pressure, from gas usage, etc.

When the pressure in the system, and thus the chamber 134, falls below a set threshold (which can either be factory set or set by the operator prior to welding), the pressure sensor or switch 135 emits a signal which causes the control system (not shown) to switch off either of the welder 10 or the welding gun 11. Thus, the present invention prevents a welding operation from continuing when the gas pressure drops below a level which will ensure proper welding.

When the welding operation stops, the gas flow stops which brings the gas pressure in the system back to a stable, static state. However, it is well known that when the gas in the system reaches a stable state, the dead-head pressure within the system is higher than the dynamic system pressure during operation. For example, if during operation the dynamic system pressure drops to 2 PSI, which triggers system shut down, when the gas stops flowing the dead head pressure may go as high as 10 PSI.

Because the dead head pressure may be higher than the low threshold pressure set for the pressure sensor or switch 135, without the presence of the pressure isolation chamber 134, the pressure sensor or switch 135 would be misled to believe that the pressure within the system is high enough to continue welding. Stated differently, because of the presence of the check valve 132 and the normally closed valve 131 in the manifold 13, the system dead head pressure is held outside of the chamber 134, so that the pressure sensor or switch 135 is shielded from the system dead head pressure.

With this shielding, the operator will be unable to continue the welding operation, without intentionally checking the system and determining if sufficient gas pressure exists to continue welding. Once confirming this, the operator must then again open the normally closed valve so that the pressure within the chamber 134 equalizes with the system pressure, and if the pressure is above the threshold level pf the pressure sensor or switch 135, then the welding system will be able to operate. However, again, once the dynamic system pressure drops below the set threshold level, the pressure sensor or switch 135 emits signals which causes the welding operation to stop.

The above aspects of the present invention ensures that an operator must actively reset the system, via the normally closed valve 131 and any other system reset controls that may be placed on the welder 10. By requiring such active input by the operator, the present invention requires the operator to evaluate the level of gas within the system and make an affirmative decision to continue welding. Thus, the present invention aids in preventing substandard welds which result from an insufficient amount of shielding gas, while at the same time ensuring that the maximum amount of gas in the tank 12 is used, thus greatly improving efficiency and reducing gas waste (i.e. cost). Essentially, the present invention eliminates the need for a welder to “guess” as to when the amount of gas in the tank 12 requires the tank to be replaced.

It is noted that the present invention is not limited to the above description of the manifold 13 structure, and that any structure or configuration can be utilized where a pressure isolation chamber is created which is shielded from increases in system pressure (due to a change from dynamic or working pressure to static pressure), but allows the pressure in the chamber to drop with the system pressure, as the system pressure decreases from gas depletion, etc. For example, it is contemplated that the manifold 13 of the present invention contains a pressure relief valve (shown in dashed lines of FIG. 3), to relieve pressure within the chamber 134 as needed. Additionally, optionally a pressure gauge 136 may be installed to provide the operator with the system pressure of the gas system.

FIG. 2 shows another welding system 200 using another embodiment of the present invention. Specifically, FIG. 2 shows a welder 20 coupled to a welding gun 21 and a shielding gas supply tank 22 via a gas supply system. Coupled to the system between the tank 22 and the welder 20 is a normally closed solenoid valve 23, which operates similar to the valve 131 of FIG. 4. Namely, this valve remains in the closed position such that when the valve 23 is not held open, either manually or electrically. Thus, this valve 23 prevents the flow of gas in either direction. However, similar to the manifold 13 structure shown in FIG. 4, the valve 23 is coupled with a directional flow valve or check valve 24 which prevents the flow in one direction, but allows the flow in another direction (see the arrow).

Thus, similar to the operation of the manifold 13, in FIG. 4, the section of the gas system 25 between the valves 23 and 24 acts as a pressure isolation chamber between a pressure switch 26 and the valves 23/24. Because of this, the overall operation of the embodiment in FIG. 2 is similar to that described above regarding FIG. 1. This discussion is not repeated. In an embodiment of this aspect of the invention, a reset switch (not shown) may be used to control the normally closed valve 23, to open the valve 23 temporarily, allowing the pressure in the gas system portion 25 to equalize with the system pressure.

In this embodiment, the check valve 24 and the solenoid valve 23 are coupled to each other in a manifold structure (not shown) which is similar in structure to the manifold 13 in FIG. 4. The manifold permits the proper operation of the check valve and solenoid valve to ensure that the dead head pressure is blocked from downstream of the manifold (thus the operation is essentially as discussed with regard to FIG. 1). However, in this manifold structure the pressure switch is located downstream from the manifold.

FIG. 3 shows another exemplary embodiment of a welding system 300 of the present invention. Specifically, FIG. 3 shows a welder 30 coupled to a welding gun 31 and a shielding gas supply tank 32 via a gas supply system. Coupled to the system between the tank 32 and the welder 30 is a normally closed solenoid valve 35, which can be controlled electrically. The valve 35 is coupled to a pressure switch 36 via some gas tubing 34 or manifold type structure. Both the pressure switch 36 and the valve 35 are electrically coupled to a control circuit 37, which is coupled to the welder 30 and/or the welding gun 31. Although FIG. 3 shows the control circuit 37 external to the welder 30, it is contemplated that the control circuit may be internal to the welder 30. The present invention is not limited to the configuration or location of the circuit 371 as long as the operation of the circuit and the invention is maintained. Further, although it is shown that the circuit 37 is coupled to the welder 30, the circuit may also be coupled to the welding gun 31. Further, as shown in FIG. 3, the control circuit 37 may receive only a single signal from the switch 36 to control the valve 35 and the welding operation. However, it is also contemplated that the switch may send out at least two signals, where one is directed to control the valve 35 and the other is sent to independently control the welding operation.

In the FIG. 3 embodiment, it is shown that the valve 35 and the switch 36 are separated from each other by a section of tubing 34. It is also contemplated that similar to FIG. 1, the valve 35 and the switch 36 an be incorporated into a single manifold structure having a pressure isolation chamber. The present embodiment is not limited to the shown configuration, but can be used in many structures where the overall operation of the system is maintained consistent with the invention.

The operation of the embodiment shown in FIG. 3 will now be discussed.

Similar to the above embodiments, the tubing 34 acts as a pressure isolation chamber between the valve 35 and the pressure switch 36. Thus, the overall operation of this system is similar to that of FIGS. 1 and 2. Prior to operation of the welding system 300, the valve 35 is in the closed position. Thus, the system dead head pressure does not reach the switch 36 when the gas from the tank 32 is released into the system. Prior to welding, the valve 35 is opened, either manually or via an electronic switch (not shown), which permits the welding gas from the tank 32 to reach the pressure switch 36. The pressure switch 36 detects the pressure within the tubing 34 and if the pressure is above a minimum threshold the control circuit 37, via a signal from the switch 36, energizes or otherwise controls the solenoid valve 35 to hold the valve in the open position and permits a welding operation to begin. By having the valve 35 remain open, the pressure sensed by the switch 36 is the system operating pressure. When this pressure drops below a minimum threshold, and a signal is sent to the control circuit 37, the control circuit 37 de-energizes the solenoid valve 35, which then closes. Additionally, the control circuit 37 shuts down operation of either the welder 30 or the welding gun 31, or both. By closing the valve 35, similar to the above embodiments, the tubing 34 between the valve 35 and the switch 36 acts as a pressure isolation chamber which holds the last level of operating pressure of the gas system. Thus, the system dead head pressure is held at the valve 35, such that the switch 36 is prevented from being exposed to this higher pressure, as in the other embodiments. Therefore, to continue the welding operation, an operator must investigate the system gas level, and then re-open the valve 35. When the valve 35 is re-opened, the system will only operate if the switch 36 senses sufficient system pressure.

Of course, it is contemplated that the control circuit 37 and other electrical aspects of the system can be configured in any way such that the spirit of the invention is maintained, and the invention is not limited to the exemplary embodiment discussed above.

The present invention has been described with certain embodiments and applications. These can be combined and interchanged without departing from the scope of the invention as defined in the appended claims. Namely, the present invention can be used in any application in which it is necessary to maintain gas or liquid flow at a required amount or rate. The invention as defined in these appended claims are incorporated by reference herein as if part of the description of the novel features of the present invention.

I claim:

1. A system for shutting down a welding device, said system comprising:
a pressure isolation chamber having an inlet portion;
a first valve device in communication with said inlet portion and said pressure isolation chamber which controls flow from said inlet portion into said pressure isolation chamber;
a second valve device in communication with said pressure isolation chamber which is configured to allow pressure in said pressure isolation chamber to decrease and prevent pressure in said pressure isolation chamber from increasing; and
a pressure sensing device which is in communication with the pressure isolation chamber which senses said pressure and emits a signal when said pressure falls below a threshold level.

2. The system of claim 1, wherein the signal is used to stop at least one of a welding device or a welding gun from operating.

3. The system of claim 1, wherein the first valve device is a normally closed valve.

4. The system of claim 3, wherein the first valve device is an electrically controlled solenoid valve.

5. The system of claim 1, wherein the first valve device is an electrically controlled solenoid valve.

6. The system of claim 1, wherein the second valve device is a one way directional flow control valve.

7. The system of claim 1, wherein each of the pressure isolation chamber, inlet portion, first valve device, second valve device and pressure sensing device are coupled to each other with a single manifold structure.

8. The system of claim 1, wherein said pressure is generated from a welding shielding gas.

9. The system of claim 1, wherein a pressure gauge is coupled to said pressure isolation chamber which measures said pressure.

10. The system of claim 1, wherein said first and second valve devices are integrated into a single manifold structure.

11. A welding system, said system comprising:
a welding device coupled to a welding gun used to perform a welding operation,
a tank containing a shielding gas coupled to at least one of said welding device and welding gun so as to provide said shielding gas during a welding operation; and
a shut down system to shut down at least one of said welding device and welding gun, said shut down system comprising:
a pressure isolation chamber having an inlet portion which is in communication with said tank;
a first valve device in communication with said inlet portion and said pressure isolation chamber which controls flow of said gas from said inlet portion into said pressure isolation chamber;
a second valve device in communication with said pressure isolation chamber which is configured to allow pressure in said pressure isolation chamber to decrease and prevent pressure in said pressure isolation chamber from increasing; and
a pressure sensing device which is in communication with the pressure isolation chamber which senses said pressure and emits a signal when said pressure falls below a threshold level.

12. The system of claim 1, wherein the signal is used to stop at least one of the welding device or the welding gun from operating.

13. The system of claim 11, wherein the first valve device is a normally closed valve.

14. The system of claim 13, wherein the first valve device is an electrically controlled solenoid valve.

15. The system of claim 11, wherein the first valve device is an electrically controlled solenoid valve.

16. The system of claim 11, wherein the second valve device is a one way directional flow control valve.

17. The system of claim 1, wherein each of the pressure isolation chamber, inlet portion, first valve device, second valve device and pressure sensing device are coupled to each other with a single manifold structure.

18. The system of claim 11, wherein said pressure is generated from said shielding gas.

19. The system of claim 11, wherein a pressure gauge is coupled to said pressure isolation chamber which measures said pressure.

20. The system of claim 11, wherein said first and second valve devices are integrated into a single manifold structure.

21. A method of shutting down a welding operation, said method comprising:
providing shielding gas from a shielding gas source to a pressure isolation chamber so as achieve a pressure level within said chamber;
performing a welding operation using at least some of said shielding gas from said shielding gas source;
allowing at least some of said shielding gas within said pressure isolation chamber to escape said chamber during said welding operation;
sensing said pressure within said chamber and providing a signal to at least one of a welding device or a welding gun, used for said welding operation, to shut down at least one of said welding device or welding gun when said pressure drops below a pressure threshold level; and
preventing any additional amount of said shielding gas from entering said pressure isolation chamber after said at least one of said welding device and welding gun is shut down.

22. The method of claim 21, further comprising using a normally closed valve which is controlled either manually or electrically to provide said shielding gas from said shielding gas source to said pressure isolation chamber.

23. The method of claim 21, further comprising preventing further operation of either of said at least one of said welding device and welding gun until said pressure within said pressure isolation chamber is above said pressure threshold level.

24. A system for shutting down a welding device, said system comprising:
a pressure isolation chamber having an inlet portion;
a solenoid valve device in communication with said inlet portion and said pressure isolation chamber which controls flow from said inlet portion into said pressure isolation chamber so that pressure in said pressure isolation chamber is equal to a system pressure upstream of said solenoid valve device; and
a pressure sensing device which is in communication with the pressure isolation chamber which senses said pressure i n the pressure isolation chamber and emits a signal when said pressure falls below a threshold level;
wherein said solenoid valve device closes when said pressure in said pressure isolation chamber drops below a set threshold level.

25. The system of claim 24, wherein the signal is used to stop at least one of a welding device or a welding gun from operating.

26. The system of claim 24, wherein the solenoid valve device closes based on said signal.

27. The system of claim 26, wherein the solenoid valve device is an electrically controlled solenoid valve.

28. The system of claim 24, wherein either said signal or a second signal is sent from the pressure switch to a control circuit which closes said solenoid valve device when the pressure drops below said threshold.

29. The system of claim 24, wherein said pressure is generated from a welding shielding gas.

30. The system of claim 24, wherein a pressure gauge is coupled to said pressure isolation chamber which measures said pressure.

31. The system of claim 28, wherein at least one of the control circuit and the solenoid valve device includes a manual reset function which requires a user to manually reset the at least one of the solenoid valve device and the control circuit after said solenoid valve device is closed.

32. The system of claim 24, wherein said solenoid valve device and said pressure switch are integrated into a single manifold structure.

33. The system of claim 24, further comprising a control circuit which holds the solenoid valve device in an open position when the pressure within the pressure isolation chamber is above said threshold.
